(19) United States
(12) Patent Application Publication
(10) Pub. No.: US 2026/0196590 A1
(43) Pub. Date: Jul. 9, 2026

(54) COOLANT HOSE CONNECTION SYSTEM FOR ALIGNING A COOLANT HOSE WITH A COLD PLATE CONNECTOR FOR AN ELECTRIC VEHICLE BATTERY COOLING SYSTEM

(71) Applicant: GM GLOBAL TECHNOLOGY OPERATIONS LLC, Detroit, MI (US)

(72) Inventors: Jack G. MICHALSKI, Ferndale, MI (US); Jeffery J. MILTON, Clarkston, MI (US)

(21) Appl. No.: 19/011,174

(22) Filed: Jan. 6, 2025

(51) Int. Cl. H01M 10/613; B60K 11/02; H01M 10/625; H01M 10/6554; H01M 10/656; H01M 50/204; H01M 50/249

(52) U.S. Cl. CPC H01M 10/613; H01M 10/625; H01M 10/6554; H01M 10/656; H01M 50/204; H01M 50/249; B60K 11/02; H01M 2220/20

(57) ABSTRACT

A coolant hose connection system for joining a coolant hose with a cold plate spigot on a cold plate includes an alignment cup including a first end having a cold plate spigot receiver and a second end including a conduit spigot support section. A conduit spigot is arranged on the conduit spigot support section. The conduit spigot includes a first end section configured to receive the cold plate spigot, a second end section configured to connect with a coolant conduit, and a clocking element. A conduit spigot retainer is coupled to the alignment cup. The conduit spigot retainer includes a clocking element receiver configured to receive the clocking element to establish a selected alignment between the conduit spigot and the cold plate spigot.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of electric vehicle battery cooling systems and, more particularly, to a coolant hose connection system that promotes alignment of a coolant hose with a cold plate connector.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators arranged in a battery cell stack located in a battery cell enclosure (or cell can). The cathode electrodes include a cathode active material layer arranged on a cathode current collector. The anode electrodes include an anode active material layer arranged on an anode current collector. The cathode and anode electrodes are connected to cathode and anode terminals arranged on an outer surface of the enclosure.

Battery modules or packs typically include a housing that supports and surrounds the battery cells. The terminals of the battery cells are interconnected to provide a desired output voltage. In many cases, the battery modules rest on a cooling plate in the housing. A cooling fluid is passed through the cooling plate in a heat exchange relationship with the battery modules. The cooling plate lowers an overall temperature of the battery module to improve battery efficiency.

### SUMMARY

A coolant hose connection system for joining a coolant hose with a cold plate spigot on a cold plate, in accordance with the present disclosure, includes an alignment cup including a first end having a cold plate spigot receiver and a second end including a conduit spigot support section. A conduit spigot is arranged on the conduit spigot support section. The conduit spigot includes a first end section configured to receive the cold plate spigot, a second end section configured to connect with a coolant conduit, and a clocking element. A conduit spigot retainer is coupled to the alignment cup. The conduit spigot retainer includes a clocking element receiver configured to receive the clocking element to establish a selected alignment between the conduit spigot and the cold plate spigot.

In other features, the clocking element comprises a projection extending outwardly of the conduit spigot.

In other features, the clocking element receiver comprises an opening formed in the conduit spigot retainer.

In other features, the opening is larger than the clocking element, the opening being configured to facilitate an amount of rotation of the conduit spigot retainer relative to the conduit spigot.

In other features, the cold plate spigot includes a spigot base configured to connect to the cold plate and a spigot nipple extending from the spigot base, the spigot nipple fluidically connecting the cold plate with a coolant conduit.

In other features, the conduit spigot retainer includes an alignment pin configured to establish a selected alignment between the conduit spigot retainer and the cold plate and the spigot base includes a locator slot configured to receive the alignment pin on the conduit spigot retainer.

In other features, the conduit spigot retainer includes a mounting ear having a fastener opening.

In other features, the spigot base includes a threaded passage, the fastener opening being configured to align with the threaded passage when the alignment pin extends into the locator slot.

In other features, the conduit spigot support section includes a first groove portion, and the conduit spigot retainer includes a second groove portion, the first groove portion and the second groove portion forming an annular groove when the alignment cup and the conduit spigot retainer are connected.

In other features, the conduit spigot includes an annular boss that is received in the annular groove formed in the conduit spigot retainer and the alignment cup.

A battery system for a vehicle, in accordance with the present disclosure, includes a housing, a plurality of cells arranged in the housing, and a cold plate supporting the housing. The cold plate includes a coolant inlet and a coolant outlet. The coolant inlet includes a first cold plate spigot and the coolant outlet including a second cold plate spigot. A coolant supply conduit includes a first conduit spigot fluidically connected to the first cold plate spigot and a coolant outlet conduit including a second conduit spigot fluidically connected to the second cold plate spigot. A coolant hose connection system joins the coolant supply conduit with the first cold plate spigot. The coolant hose connection system includes an alignment cup including a first end having a cold plate spigot receiver and a second end including a conduit spigot support section. A conduit spigot is fixedly connected to the coolant supply conduit and arranged on the conduit spigot support section. The conduit spigot includes a first end section fluidically connected with the first cold plate spigot, a second end fixedly connected with the coolant supply conduit, and a clocking element. Aa conduit spigot retainer is coupled to the alignment cup. The conduit spigot retainer includes a clocking element receiver configured to receive the clocking element to establish a selected alignment between the conduit spigot and the first cold plate spigot.

In other features, the clocking element comprises a projection extending outwardly of the conduit spigot.

In other features, the clocking element receiver comprises an opening formed in the conduit spigot retainer.

In other features, the opening is larger than the clocking element, the opening being configured to facilitate an amount of rotation of the conduit spigot retainer relative to the conduit spigot.

In other features, the first cold plate spigot includes a spigot base connected to the cold plate and a spigot nipple extending from the spigot base, the spigot nipple fluidically connecting the cold plate with the coolant supply conduit.

In other features, the conduit spigot retainer includes an alignment pin configured to establish a selected alignment between the conduit spigot retainer and the cold plate and the spigot base includes a locator slot configured to receive the alignment pin on the conduit spigot retainer.

In other features, the conduit spigot retainer includes a mounting ear having a fastener opening.

In other features, the spigot base includes a threaded opening, the fastener opening being configured to align with the threaded opening when the alignment pin on the conduit spigot retainer extends into the locator slot.

In other features, the conduit spigot support section of the alignment cup includes a first groove portion, and the conduit spigot retainer includes a second groove portion, the first groove portion and the second groove portion forming an annular groove when the alignment cup and the conduit spigot retainer are connected.

In other features, the conduit spigot includes an annular boss that is received in the annular groove formed in the conduit spigot retainer and the alignment cup.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side view of a vehicle including an electric vehicle battery cooling systems coolant hose connection system, in accordance with the present disclosure;

FIG. 2 is a partial perspective view depicting an electric vehicle battery resting on a cold plate that is connected to coolant supply and return conduits through the coolant hose connection system, in accordance with the present disclosure;

FIG. 3 is a cross-sectional view of the coolant hose connection system, in accordance with the present disclosure;

FIG. 4 is a perspective view of a cold plate including cold plate spigots of the coolant hose connection system, of the present disclosure;

FIG. 5 is a cross-sectional view of one of the cold plate spigots of FIG. 4 taken through the line 5-5, in accordance with the present disclosure;

FIG. 6 is a top view of one of the cold plate spigots of FIG. 4, in accordance with the present disclosure;

FIG. 7 is a perspective view of a conduit spigot connector attached to one of the cold plate spigots of FIG. 4, in accordance with the present disclosure;

FIG. 8 is a cross-sectional view of the conduit spigot connector attached to the one of the cold plate spigots taken through the line 8-8 in FIG. 7, in accordance with the present disclosure;

FIG. 9 is a disassembled view of the conduit spigot connector of FIG. 7, in accordance with the present disclosure; and

FIG. 10 is a top view of the conduit spigot connector of FIG. 7, in accordance with the present disclosure.

In the drawings, reference numbers may be reused to identify similar and/or identical elements.

### DETAILED DESCRIPTION

While described in terms of cooling a battery for an electric vehicle, the connection system according to the present disclosure may be applicable to non-vehicle implementations.

In operation, batteries generate heat.

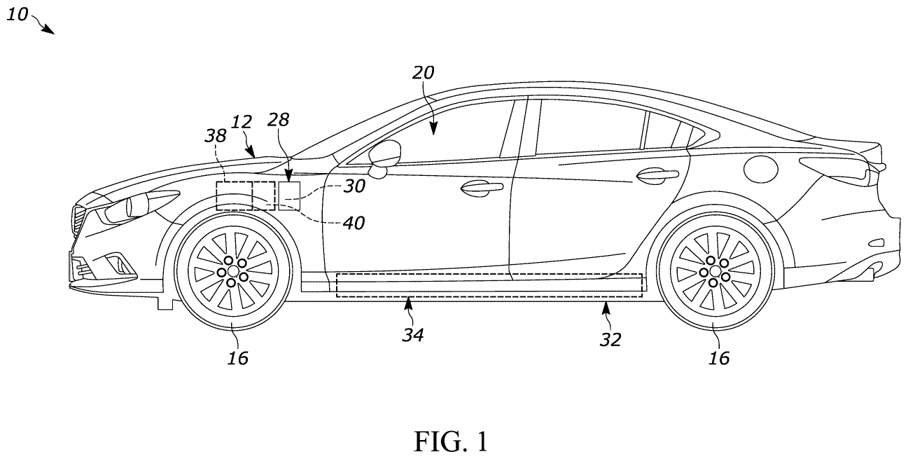

A vehicle, in accordance with a non-limiting example, is indicated generally at 10 in FIG. 1. Vehicle 10 includes a body 12 supported on a plurality of wheels, two of which are indicated at 16. Body 12 defines, in part, a passenger compartment 20. Body 12 includes a charge port cover 28 that houses a charge port 30. Vehicle 10 includes a chassis 32 that supports a battery assembly 34 electrically connected to charge port 30. Chassis 32 is further shown to support a motor 38 that is electrically connected to battery assembly 34 and a drivetrain 40. Drivetrain 40 transfers motive power from motor 38 to one or more of the plurality of wheels 16.

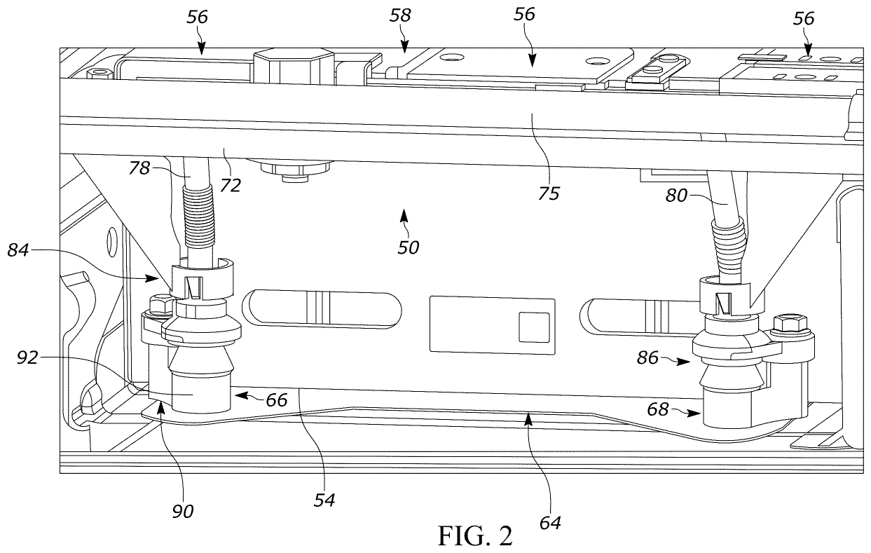

Battery assembly 34 includes a housing 50 as shown in FIG. 2. Housing 50 is supported by a base wall 54 and includes battery cell receiving zone 58. A plurality of prismatic can battery cells 56 are arranged in battery cell receiving zone 58. The number, arrangement of, and connection of battery cells 56 may vary. Housing 50 sits on a cold plate 64. More specifically, base wall 54 is in a heat exchange relationship with cold plate 64. As will become more fully evident herein, an amount of coolant is circulated through cold plate 64 in an effort to reduce operating temperatures of battery assembly 34.

Cold plate 64 includes a coolant inlet 66 and a coolant outlet 68. Coolant inlet 66 is fluidically connected to a coolant inlet conduit 72 and coolant outlet 68 is fluidically connected to a coolant outlet conduit 75. Coolant inlet conduit 72 and coolant outlet conduit 75 serve a plurality of cooling circuits (not separately labeled) arranged in cold plate 64. A first coolant hose or drop 78 fluidically connects coolant inlet conduit 72 with coolant inlet 66 and a second coolant hose or drop 80 fluidically connects coolant outlet conduit 75 with coolant outlet 68. A first coolant hose connector 84 connects first coolant hose 78 with coolant inlet 66 and a second coolant connector 86 connects second coolant hose 80 with coolant outlet conduit 75.

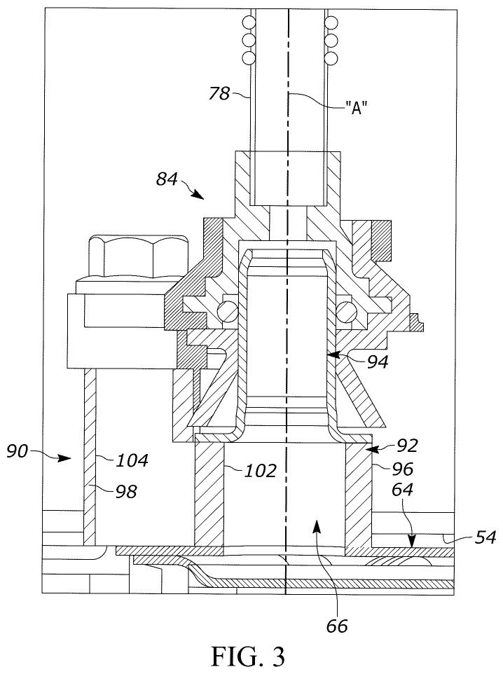

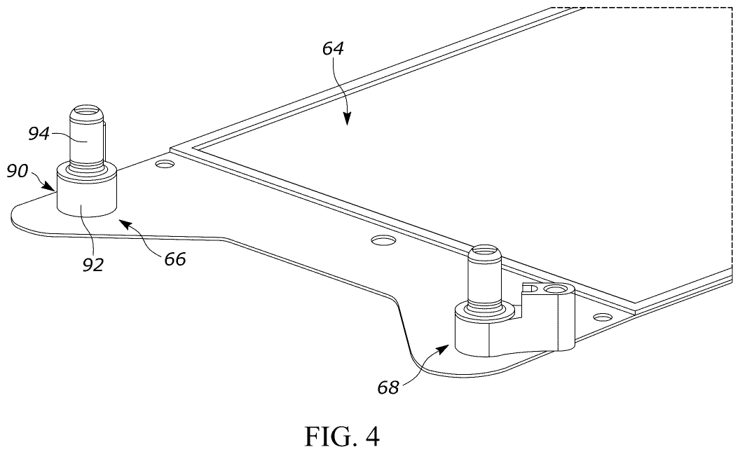

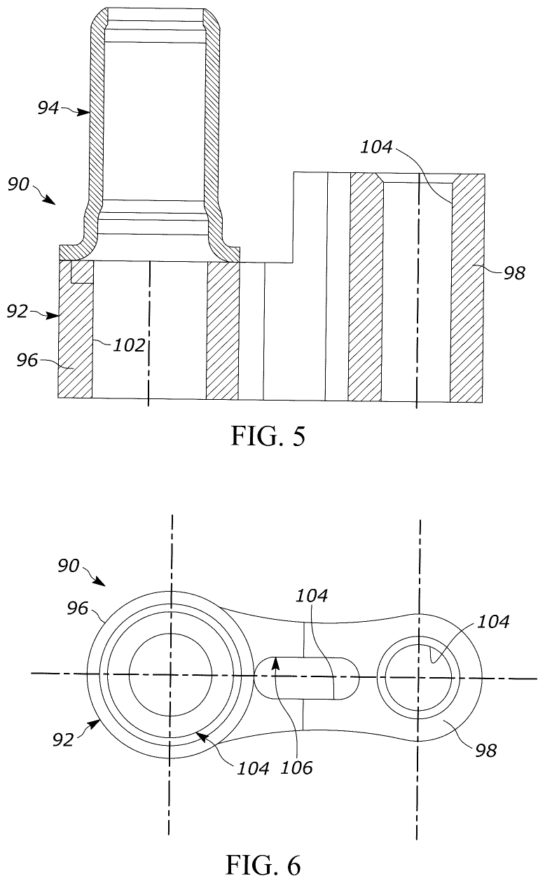

Reference will now follow to FIGS. 3, 4, 5, and 6 in describing first coolant hose connector 84 with an understanding that second coolant hose connector 86 is similarly formed. First coolant hose connector 84 includes a cold plate spigot 90 that forms coolant inlet 66. Cold plate spigot 90 includes a spigot base 92 fixedly mounted to cold plate 64 and a spigot nipple 94 that provides a passage for coolant flowing from coolant inlet conduit 72 into cold plate 64.

In accordance with the present disclosure, spigot base 92 includes a first section 96 and a second section 98. First section 96 supports spigot nipple 94 and includes a passage 102. Second section 98 includes a threaded opening or passage 104. A locator slot 106 (FIG. 6) is arranged between passage 102 and threaded opening 104. Locator slot 106 includes an elongated opening 108 that facilitates alignment between first coolant hose 78 and spigot nipple 94 as will be detailed more fully herein.

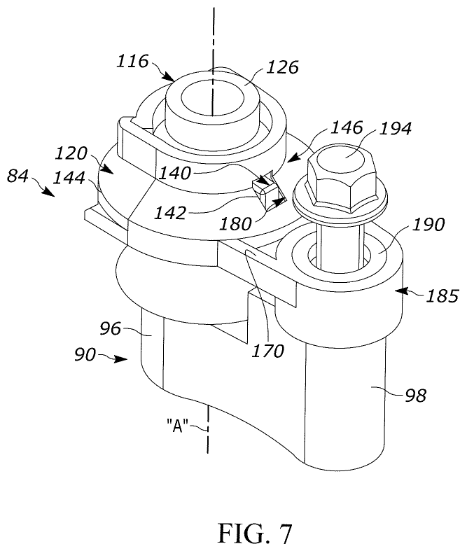

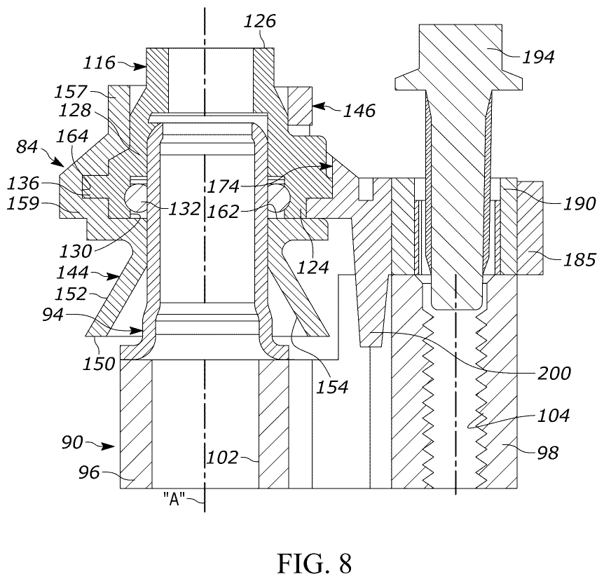

In accordance with the present disclosure illustrated in FIGS. 7, 8, and 9, first coolant hose connector 84 includes a conduit spigot 116 and an alignment system 120. Conduit spigot 116 provides a fluidic interface between first coolant hose 78 and spigot nipple 94. Alignment system 120 joins conduit spigot 116 to cold plate spigot 90. Alignment system 120 also facilitates alignment between conduit spigot 116 and spigot nipple 94. That is, as will be detailed more fully herein, alignment system 120 may rotate relative to conduit spigot 116 so as to accommodate misalignments when connecting first coolant hose 78 with spigot nipple 94.

In accordance with the present disclosure, conduit spigot 116 includes a first end section 124 that receives spigot nipple 94, a second end section 126 that is fixedly connected to first coolant hose 78 and an interface portion 128 that is retained by alignment system 120. In accordance with a non-limiting example, second end section 126 may be brazed to first coolant hose 78. As such, conduit spigot 116 does not rotate relative to first coolant hose 78.

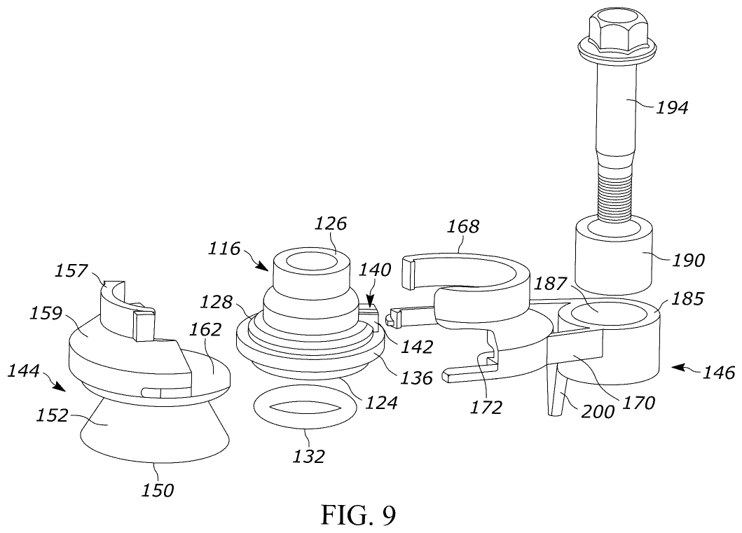

First end section 124 includes an O-ring recess 130 that accommodates an O-ring 132 that seals against spigot nipple 94. Interface portion 128 includes an annular boss 136 that is captured by alignment system 120. Interface portion 128 also includes a clocking element 140 (FIG. 9), shown as a rectangular projection 142 that projects outwardly of conduit spigot 116. Clocking element 140 provides a selected alignment of conduit spigot 116 and alignment system 120.

In accordance with the present disclosure, alignment system 120 includes an alignment cup 144 and a conduit spigot retainer 146 that cooperate to capture conduit spigot 116 and promote a connection with spigot nipple 94. Alignment cup 144 includes a first end 150 having flared sides 152 that define a flared opening 154, a second end 157, and a conduit spigot support section 159. First end 150 is configured to guide cold plate spigot 90 into a connection with conduit spigot 116. That is, cold plate spigot 90 is received by and fluidically connects with conduit spigot 116 within alignment cup 144.

In accordance with the present disclosure, conduit spigot support section 159 includes a support surface 162 upon which rests conduit spigot 116 and a first groove portion 164 which, as will be discussed more fully herein secures conduit spigot 116 in alignment cup 144. Conduit spigot retainer 146 includes a spigot retainer portion 168 and a connector portion 170. Spigot retainer portion 168 cooperates with alignment cup 144 to secure conduit spigot 116 and includes a second groove portion 172. First groove portion 164 and second groove portion 172 form an annular groove 174 that receives annular boss 136 on conduit spigot 116.

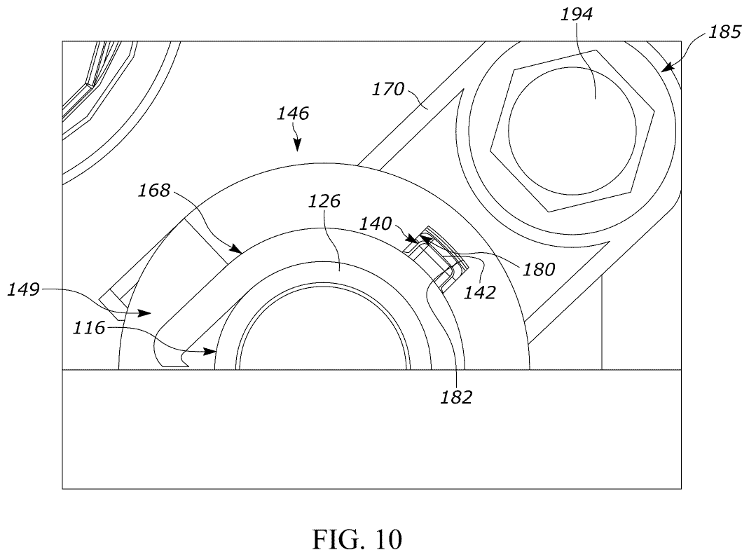

Connector portion 170 provides an interface with spigot base 92 as well as an amount of rotational flexibility that may accommodate misalignments between conduit spigot 116 and cold plate spigot 90. Connector portion 170 extends from spigot retainer portion 168 and includes a clocking element receiver 180 defined by an opening 182. Clocking element receiver 180, as shown in FIG. 10, receives clocking element 140 on conduit spigot 116. Opening 182 is larger than clocking element 140. In this manner, spigot retainer portion 168 may rotate about an axis “A” extending through cold plate spigot 90 and conduit spigot 116.

Connector portion 170 also includes a mounting ear 185 having a fastener opening 187 provided with a bushing 190. A fastener 194 is passed through fastener opening 187 into passage 102 in spigot base 92. An alignment pin 200 extends from mounting ear 185 downwardly from connector portion 170. Alignment pin 200 is inserted into locator slot 106 in spigot base 92. The geometry of locator slot 106 provides additional flexibility in aligning conduit spigot 116 with cold plate spigot 90. It should be noted that the particular location of locator slot 106 and alignment pin 200 may vary. For example, alignment pin 200 may be on the spigot base 92 and locator slot 106 be formed in the conduit spigot retainer 146.

Fastener 194 is secured to spigot base 92 resulting in conduit spigot 116 is fluidically secured to cold plate spigot 90. Mounting ear 185 may be rotated about axis “A” in order to align fastener opening 187 with passage 102. The amount of rotation is constrained by the size of clocking element receiver 180. This rotation overcomes shortcomings in the prior art in which the fastener was constrained to the conduit spigot and thus alignment between components was more critical, time consuming, and costly to achieve. Any misalignments in the prior art had to be corrected by cutting the conduit spigot from the conduit and starting over with a renewed connection.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. A coolant hose connection system for joining a coolant hose with a cold plate spigot on a cold plate, the coolant hose connection system comprising:
an alignment cup including a first end having a cold plate spigot receiver and a second end including a conduit spigot support section;
a conduit spigot arranged on the conduit spigot support section, the conduit spigot including a first end section configured to receive the cold plate spigot, a second end section configured to connect with a coolant conduit, and a clocking element; and
a conduit spigot retainer coupled to the alignment cup, the conduit spigot retainer including a clocking element receiver configured to receive the clocking element to establish a selected alignment between the conduit spigot and the cold plate spigot.

2. The coolant hose connection system according to claim 1, wherein the clocking element comprises a projection extending outwardly of the conduit spigot.

3. The coolant hose connection system according to claim 2, wherein the clocking element receiver comprises an opening formed in the conduit spigot retainer.

4. The coolant hose connection system according to claim 3, wherein the opening is larger than the clocking element, the opening being configured to facilitate an amount of rotation of the conduit spigot retainer relative to the conduit spigot.

5. The coolant hose connection system according to claim 1, wherein the cold plate spigot includes a spigot base configured to connect to the cold plate and a spigot nipple extending from the spigot base, the spigot nipple fluidically connecting the cold plate with a coolant conduit.

6. The coolant hose connection system according to claim 5, wherein the conduit spigot retainer includes an alignment pin configured to establish a selected alignment between the conduit spigot retainer and the cold plate and the spigot base includes a locator slot configured to receive the alignment pin on the conduit spigot retainer.

7. The coolant hose connection system according to claim 6, wherein the conduit spigot retainer includes a mounting ear having a fastener opening.

8. The coolant hose connection system according to claim 7, wherein the spigot base includes a threaded passage, the fastener opening being configured to align with the threaded passage when the alignment pin extends into the locator slot.

9. The coolant hose connection system according to claim 1, wherein the conduit spigot support section includes a first groove portion, and the conduit spigot retainer includes a second groove portion, the first groove portion and the second groove portion forming an annular groove when the alignment cup and the conduit spigot retainer are connected.

10. The coolant hose connection system according to claim 9, wherein the conduit spigot includes an annular boss that is received in the annular groove formed in the conduit spigot retainer and the alignment cup.

11. A battery system for a vehicle comprising:
a housing;
a plurality of cells arranged in the housing;
a cold plate supporting the housing, the cold plate including a coolant inlet and a coolant outlet, the coolant inlet including a first cold plate spigot and the coolant outlet including a second cold plate spigot;
a coolant supply conduit including a first conduit spigot fluidically connected to the first cold plate spigot and a coolant outlet conduit including a second conduit spigot fluidically connected to the second cold plate spigot; and
a coolant hose connection system joining the coolant supply conduit with the first cold plate spigot, the coolant hose connection system comprising:
an alignment cup including a first end having a cold plate spigot receiver and a second end including a conduit spigot support section;
a conduit spigot fixedly connected to the coolant supply conduit and arranged on the conduit spigot support section, the conduit spigot including a first end section fluidically connected with the first cold plate spigot, a second end fixedly connected with the coolant supply conduit, and a clocking element; and
a conduit spigot retainer coupled to the alignment cup, the conduit spigot retainer including a clocking element receiver configured to receive the clocking element to establish a selected alignment between the conduit spigot and the first cold plate spigot.

12. The battery system according to claim 11, wherein the clocking element comprises a projection extending outwardly of the conduit spigot.

13. The battery system according to claim 12, wherein the clocking element receiver comprises an opening formed in the conduit spigot retainer.

14. The battery system according to claim 13, wherein the opening is larger than the clocking element, the opening being configured to facilitate an amount of rotation of the conduit spigot retainer relative to the conduit spigot.

15. The battery system according to claim 11, wherein the first cold plate spigot includes a spigot base connected to the cold plate and a spigot nipple extending from the spigot base, the spigot nipple fluidically connecting the cold plate with the coolant supply conduit.

16. The battery system according to claim 15, wherein the conduit spigot retainer includes an alignment pin configured to establish a selected alignment between the conduit spigot retainer and the cold plate and the spigot base includes a locator slot configured to receive the alignment pin on the conduit spigot retainer.

17. The battery system according to claim 16, wherein the conduit spigot retainer includes a mounting ear having a fastener opening.

18. The battery system according to claim 17, wherein the spigot base includes a threaded opening, the fastener opening being configured to align with the threaded opening when the alignment pin on the conduit spigot retainer extends into the locator slot.

19. The battery system according to claim 11, wherein the conduit spigot support section of the alignment cup includes a first groove portion, and the conduit spigot retainer includes a second groove portion, the first groove portion and the second groove portion forming an annular groove when the alignment cup and the conduit spigot retainer are connected.

20. The battery system according to claim 19, wherein the conduit spigot includes an annular boss that is received in the annular groove formed in the conduit spigot retainer and the alignment cup.
